(19) United States
(12) Patent Application Publication
(10) Pub. No.: US 2021/0147075 A1
(43) Pub. Date: May 20, 2021

(54) LANDING APPARATUS, LANDING CONTROL METHOD, AND LANDING CONTROL PROGRAM

(71) Applicant: NEC Corporation, Minato-ku, Tokyo (JP)

(72) Inventors: Masafumi EMURA, Tokyo (JP); Masatsugu OGAWA, Tokyo (JP); Masumi ICHIEN, Tokyo (JP)

(73) Assignee: NEC Corporation, Minato-ku, Tokyo (JP)

(21) Appl. No.: 16/626,705

(22) PCT Filed: Jun. 30, 2017
(86) PCT No.: PCT/JP2017/024076

§ 371 Date: Dec. 26, 2019

(51) Int. Cl. B64C 39/02; B64D 45/08; G05D 1/10; B64D 17/80

(52) U.S. Cl. CPC B64C 39/024; B64D 45/08; G05D 1/105; B64C 2201/024; B64C 2201/127; B64C 2201/185; B64C 2201/042; B64D 17/80

(57) ABSTRACT

Provided is a landing apparatus which guides an unmanned aircraft to avoid obstacles and lands the unmanned aircraft at a low-risk spot. The landing apparatus has a dangerous object position detecting device, a movement target spot calculating device, and a parachute control device. The dangerous object position detecting device detects the position of a dangerous object that is present in the vicinity of the unmanned aircraft attempting to land using a parachute. Based on the position of the dangerous object, the movement target spot calculating device calculates a movement target spot to which the unmanned aircraft should move at each instance in order to avoid colliding with the dangerous object and landing on a dangerous site. The parachute control device controls the parachute so that the unmanned aircraft moves to the movement target spot calculated by the movement target spot calculating device.

### TECHNICAL FIELD

The present invention relates to a landing apparatus, a landing control method, and a landing control program.

### BACKGROUND ART

Nowadays, a delivery system and a monitoring system utilizing an unmanned aircraft have been developed, and an unmanned aircraft control system and the like for use in these applications have been developed. These systems are proposed based on a premise that an unmanned aircraft performs normal flight. However, in an actual operation, an unmanned aircraft may be uncontrollable. In view of the above, a handling method in a case where an unmanned aircraft becomes uncontrollable has been studied.

For example, PTL 1 discloses a technique in which an unmanned aircraft includes a parachute or an airbag which is to be deployed when the aircraft is unable to fly. This enables protecting an aircraft and a precision instrument mounted thereon from impact of crash.

Further, PTL 2 discloses a technique in which, when an unmanned helicopter becomes uncontrollable, an airbag and a parachute are used, and forced landing is performed. When forced landing is performed, the airbag or the parachute is selectively used depending on an altitude of the helicopter. For example, when an altitude of the helicopter is higher than a predetermined altitude, both of the parachute and the airbag are deployed; and when the altitude is lower than the predetermined altitude, only the airbag is deployed. By configuring as described above, it is possible to perform appropriate soft landing depending on an altitude.

Further, PTL 3 discloses a technique in which a suspension control rope for a parachute is provided in the parachute, and movement control of the descending parachute is performed by stretching or contracting the suspension control rope. In the technique, first, a current value is detected by a descent trajectory sensor, a global positioning system (GPS), or the like; and a descent trajectory is calculated, based on a wind direction, a falling speed, and the like. Further, by controlling stretching or contracting of the suspension control rope for the parachute, it is possible to aerodynamically control movement of the parachute, move the parachute along a target trajectory, and guide the parachute to a destination.

### CITATION LIST

### Patent Literature

[PTL 1] International Publication No. WO2016/098146

[PTL 2] Japanese Unexamined Patent Application Publication No. 2016-88111

[PTL 3] Japanese Unexamined Patent Application Publication No. H08-156893

### SUMMARY OF INVENTION

### Technical Problem

However, in the techniques in PTLs 1 and 2, since a landing place is not fixed, there is a problem that collision with an obstacle such as a tall building, a pedestrian, an automobile, or the like is unavoidable.

Further, the technique in PTL 3 is a technique in which a parachute is guided to a predetermined target place. Thus, in the technique, it is not possible to avoid an unexpected dangerous object.

In view of the above-described problems, an object of the present invention is to provide a landing apparatus for guiding an unmanned aircraft in such a way as to avoid an obstacle and the like, and landing the unmanned aircraft on a place with a low degree of danger.

### Solution to Problem

In order to solve the above problem, the landing apparatus of the present invention has a dangerous object position detecting device, a movement target spot calculating device, and a parachute control device. The dangerous object position detecting device detects the position of a dangerous object that is present in the vicinity of the unmanned aircraft attempting to land using a parachute. Based on the position of the dangerous object, the movement target spot calculating device calculates a movement target spot to which the unmanned aircraft should move at each instance in order to avoid colliding with the dangerous object and landing on a dangerous site. The parachute control device controls the parachute so that the unmanned aircraft moves to the movement target spot calculated by the movement target spot calculating device.

### Advantageous Effects of Invention

An advantageous effect of the present invention is that it is possible to provide a landing apparatus for guiding an unmanned aircraft in such a way as to avoid an obstacle and the like, and landing the unmanned aircraft on a place with a low degree of danger.

### BRIEF DESCRIPTION OF DRAWINGS

FIG. 1 is a block diagram illustrating a landing apparatus according to a first example embodiment.

FIG. 2 is a block diagram illustrating a landing apparatus according to a second example embodiment.

FIG. 3 is a perspective schematic diagram illustrating a landing apparatus according to a third example embodiment.

FIG. 4 is a block diagram illustrating the landing apparatus according to the third example embodiment.

FIG. 5 is a block diagram illustrating a parachute control device according to the third example embodiment.

FIG. 6 is a sequence diagram illustrating overall control in the third example embodiment.

FIG. 7 is a flowchart illustrating an operation of falling detection and parachute deployment in the third example embodiment.

FIG. 8 is a flowchart illustrating parachute control model configuration processing in the third example embodiment.

FIG. 9 is a block diagram illustrating a flow of processing of descent landing control and control parameter adjustment in the third example embodiment.

FIG. 10 is a schematic diagram illustrating one example of a lower danger degree determination processing result in the third example embodiment.

FIG. 11 is a schematic diagram illustrating one example of a side danger degree determination processing result in the third example embodiment.

FIG. 12 is a schematic diagram illustrating one example of route calculation until a target place in the third example embodiment.

FIG. 13 is a graph illustrating a control danger degree calculation method in the third example embodiment.

FIG. 14 is a graph illustrating an example of plotting a control danger degree at a target place in a control parameter space in the third example embodiment.

FIG. 15 is a graph illustrating a determination method of a control parameter in the control parameter space in the third example embodiment.

FIG. 16 is a block diagram illustrating a landing apparatus according to a fourth example embodiment.

FIG. 17 is a block diagram illustrating a landing apparatus according to a fifth example embodiment.

### EXAMPLE EMBODIMENT

In the following, example embodiments according to the present invention are described in detail with reference to the drawings. In the following example embodiments, although technically preferred limitations are described for implementing the present invention, the scope of the present invention is not limited to the following.

### First Example Embodiment

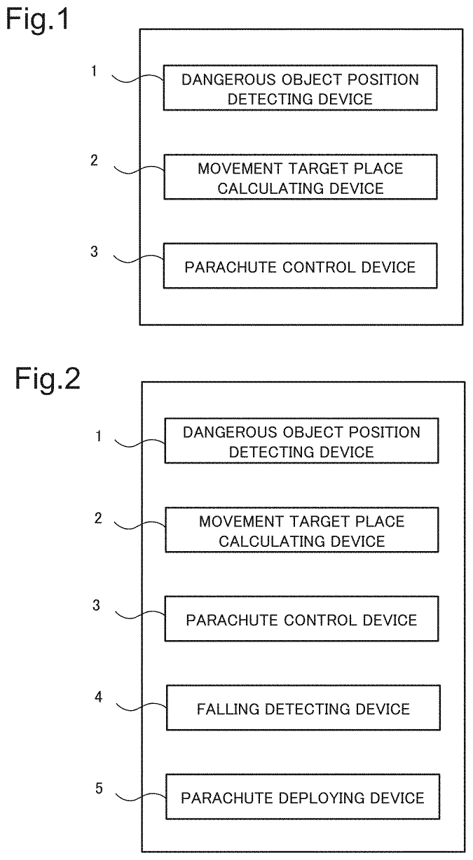

FIG. 1 is a block diagram illustrating a landing apparatus according to a first example embodiment. The landing apparatus includes a dangerous object position detecting device 1, a movement target place calculating device 2, and a parachute control device 3.

The dangerous object position detecting device 1 detects a position of a dangerous object present around an unmanned aircraft trying to land by using a parachute.

The movement target place calculating device 2 calculates a movement target place to which the unmanned aircraft is suggested to move as necessary in order to avoid collision with a dangerous object and landing on a dangerous place, based on the position of the dangerous object acquired by the dangerous object position detecting device 1.

The parachute control device 3 controls the parachute in such a way that the unmanned aircraft moves to the movement target place calculated by the movement target place calculating device.

As described above, the present example embodiment is able to provide a landing apparatus for guiding an unmanned aircraft in such a way as to avoid a dangerous object, and landing the unmanned aircraft on a place with a low degree of danger.

### Second Example Embodiment

FIG. 2 is a block diagram illustrating a landing apparatus according to a second example embodiment. The landing apparatus includes, in addition to the configuration of the first example embodiment, a falling detecting device 4 for detecting falling of an unmanned aircraft. The landing apparatus also includes a parachute deploying device 5 for deploying a parachute which suppresses falling of the unmanned aircraft.

The falling detecting device 4 determines that the unmanned aircraft is falling, when a condition that a descent speed becomes equal to or larger than a predetermined value, for example, is satisfied, and detects the falling.

The parachute deploying device 5 deploys the parachute when the falling detecting device 4 detects the falling.

A configuration and an operation of a dangerous object position detecting device 1, a movement target place calculating device 2, and a parachute control device 3 are similar to those in the first example embodiment.

By configuring as described above, when the unmanned aircraft becomes uncontrollable and starts to fall, it is possible to deploy the parachute. The landing apparatus guides the unmanned aircraft in such a way as to avoid a dangerous object, and allow the unmanned aircraft to perform emergency landing on a place with a low degree of danger.

As described above, the present example embodiment is able to configure a landing apparatus for allowing an unmanned aircraft in an uncontrollable state to safely perform emergency landing.

### Third Example Embodiment

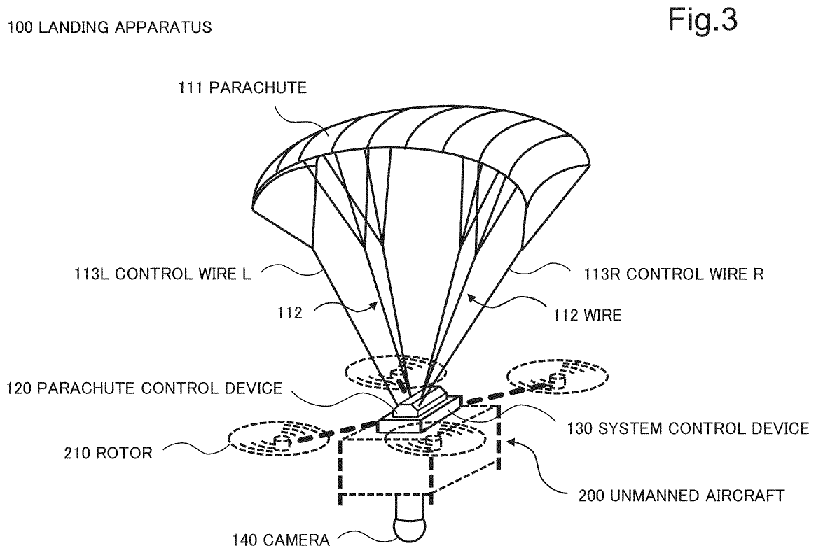

FIG. 3 is a perspective schematic diagram illustrating an overview of a landing apparatus 100 according to a third example embodiment. The landing apparatus 100 is mounted in an unmanned aircraft 200. FIG. 3 illustrates a state that an unillustrated falling detecting device detects falling of the unmanned aircraft 200, and a parachute 111 is deployed in response to the detection. Note that FIG. 3 exemplifies a multi-copter in which the unmanned aircraft 200 flies by using a plurality of rotors 210. However, the landing apparatus 100 according to the present example embodiment is also applicable to an unmanned aircraft having another configuration.

The landing apparatus 100 includes the parachute 111 deployed by a parachute deploying device (not illustrated), a parachute control device 120, a system control device 130, and a camera 140. Note that FIG. 3 illustrates an example in which the parachute 111 is of a square type. The parachute 111 is connected to the parachute control device 120 by a wire 112. Further, left and right ends of the parachute 111 are connected to the parachute control device 120 by a pair of control wires 113. Herein, the left and right control wires are respectively described as control wires L_113L and R_113R. The parachute control device 120 controls a posture and a direction of the parachute 111 by individually adjusting lengths and feeding positions of the control wires L_113L and R_113R. By the control, it is possible to control a posture and a traveling direction of the parachute 111.

The camera 140 acquires a lower image and a side image of the unmanned aircraft 200. The camera 140 is, for example, a device for acquiring image data in all directions regarding a lower direction and a side direction. For example, the camera 140 can be configured by one fisheye camera or a combination of a plurality of cameras. It is possible to detect a position where a dangerous object position is present from a lower image and a side image captured by the camera 140. As described above, as examples of the dangerous object, an obstacle such as a tall building, a pedestrian, an automobile, and the like are exemplified.

The system control device 130 analyzes an image acquired by the camera 140, and calculates, on a real-time basis, a movement target place for use when the unmanned aircraft 200 safely lands, while avoiding a dangerous object. Further, the system control device 130 outputs, to the parachute control device 120, a control signal for controlling the parachute in such a way that the unmanned aircraft moves to a movement target place at each point of time. The parachute control device 120 controls the control wires L_113L and R_113R in accordance with the control signal, and controls a posture and a moving direction of the parachute 111. By the control, the parachute 111 moves toward a target place.

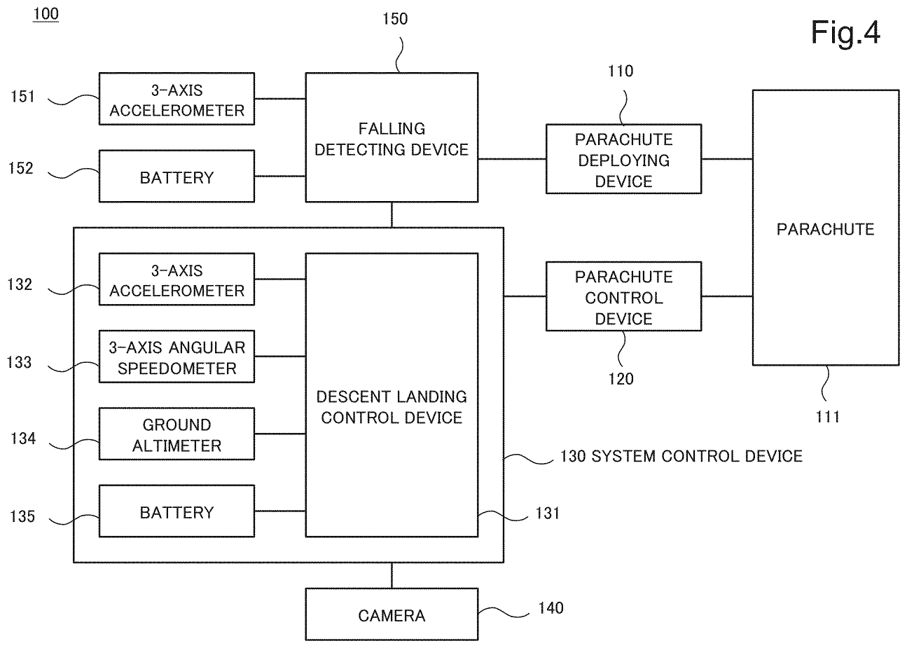

FIG. 4 is a block diagram illustrating details of the landing apparatus 100. A falling detecting device 150 detects falling of the unmanned aircraft 200 in which the landing apparatus 100 is mounted. In view of the above, the falling detecting device 150 includes a 3-axis accelerometer 151. Note that electric power for operating the falling detecting device 150 is supplied from a battery 152 herein. The falling detecting device 150 detects falling of the unmanned aircraft 200 by determining that the unmanned aircraft 200 is falling, when a downward acceleration to be output by the 3-axis accelerometer 151 satisfies a predetermined condition. The falling detecting device 150 also detects the falling when a downward speed to be calculated based on the downward acceleration satisfies a predetermined condition. The condition for determining falling can be set as when, for example, an acceleration in a ground direction becomes equal to or larger than a predetermined value. The condition for determining falling can be set as when, for example, a downward moving distance per unit time (falling speed) to be calculated from an acceleration becomes equal to or larger than a predetermined value. The falling detecting device 150 is constantly operated. Further, the falling detecting device 150 outputs, to the parachute deploying device 110, a signal of notifying falling. The parachute deploying device 110 deploys the parachute 111 in response to receiving the notification on falling. Note that, in FIG. 4, the falling detecting device 150 is separated from the system control device 130. However, the falling detecting device 150 may be configured as a part of the system control device 130.

The system control device 130 includes a descent landing control device 131. The descent landing device 131 is implemented in a computer or a processor, for example. Information from a 3-axis accelerometer 132, a 3-axis angular speedometer 133, a ground altimeter 134, and the camera 140 is input to the descent landing control device 131. Further, electric power is supplied from a battery 135 to the descent landing control device 131. The descent landing control device 131 determines information on a surrounding obstacle, and a place serving as a movement target from input values from the camera 140 and the above-described measuring instruments. Further, the descent landing control device 131 calculates a parachute control parameter for making the parachute 111 approach the movement target place. Further, the descent landing control device 131 transmits the control parameter to the parachute control device 120. The descent landing control device 131 is operated only when falling is detected by the falling detecting device 150, for example. Note that, since the falling detecting device 150 is constantly operated, individually setting batteries for driving the descent landing control device 131 and the falling detecting device 150 enables to select a battery appropriate for each of the applications.

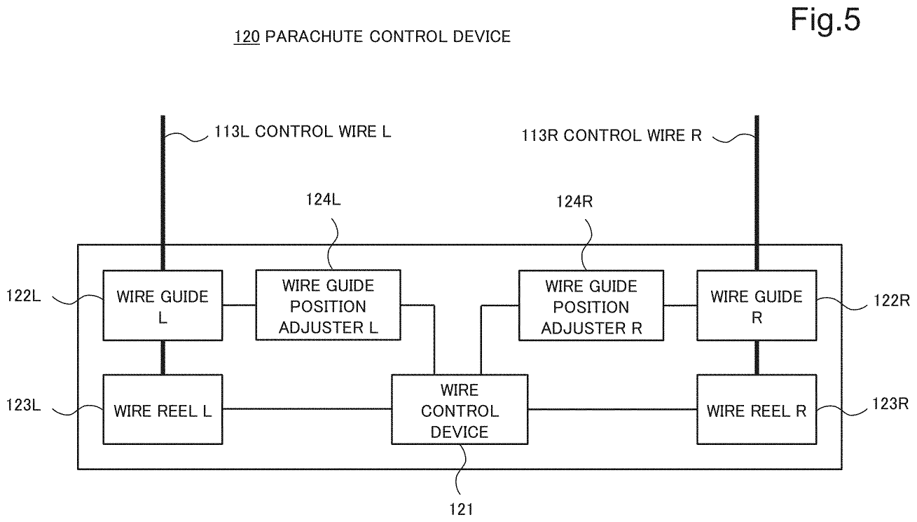

FIG. 5 is a detailed configuration diagram of the parachute control device 120. The parachute control device 120 includes a wire control device 121, and a dual control system for controlling the left and right control wires, specifically, the control wires L_113L and R_113R. The control wire L_113L is wound around a wire reel L_123L via a wire guide L_122L. Further, by rotating the wire reel L_123L, a length of the control wire L_113L is controlled. Furthermore, a position of the wire guide L_122L is controllable by a wire guide position adjuster L_124L. By the control, it is possible to adjust a feeding position of the control wire L_113L. By the above-described configuration, it is possible to control a length and a feeding position of the control wire L_113L. Likewise, it is possible to control a length and a feeding position of the control wire R_113R by a wire reel R_123R, a wire guide R_122R, and a wire guide position adjuster R_124R. According to the above-described configuration, the parachute control device 120 is able to control right turn, left turn, and a descent rate by adjusting the lengths of the left and right control wires. Further, it is possible to adjust balance of the unmanned aircraft 200 suspended from the parachute 111 by controlling a wire feeding position. As described above, the parachute control device 120 controls a posture and a moving direction of the parachute 111 by the above-described configuration, and a control signal from the descent landing control device 131. Note that, in the above-described description, it is assumed that a control wire is a pair of left and right wires. However, wires of another number, for example, wires of two or three pairs may be available. Further, it may be possible to adjust a length of the wire 112, or a mounting position of the wire 112 on the parachute control device 120.

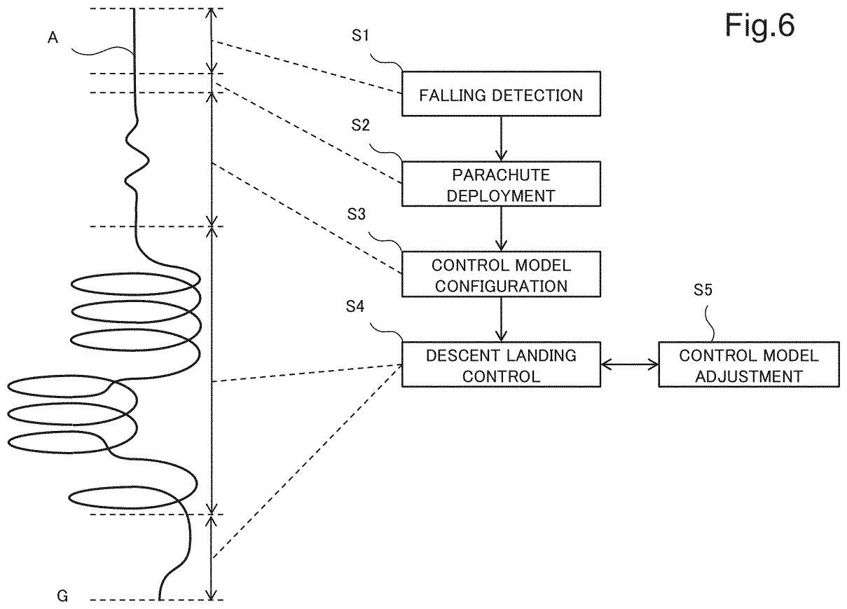

FIG. 6 is an overall control sequence diagram, when the landing apparatus 110 performs emergency landing control. In FIG. 5, A indicates a descent trajectory of an unmanned aircraft, and G indicates the ground. Falling detection S1 is a zone where falling is detected. Parachute deployment S2 is a zone where falling is detected, and a parachute is deployed. In these zones, descent control is not performed.

Control model configuration S3 is a zone where a control model characteristic value of the parachute is calculated. Note that, in the following description, a parachute control model may be referred to as a control model, and a parachute control model characteristic value may be referred to as a control model characteristic value.

The control model characteristic value is a characteristic value when a relationship between control and a behavior of a parachute is modeled. Specifically, the control model characteristic value is written as a model formula of estimating a relationship among a feeding amount (length) of a control wire for controlling a parachute and a feeding position of the control wire, and a turn rate and a descent rate of the parachute.

The following is one example of specific modeling. Herein, it is assumed that a descent rate is y, a feeding amount of a left wire is x_{1L}, a feeding position of the left wire is x_{2L}, a feeding amount of a right wire is x_{1R}, a feeding position of the right wire is x_{2R}, a horizontal moving speed of a parachute is v, and a wind velocity is w. Further, it is assumed that an air resistance on the left side of a parachute can be written by a function R_{L} (x_{1L}, x_{2L}, v, w), an air resistance on the right side of the parachute can be written by a function RR (x_{1R}, x_{2R}, v, w). Further, it is assumed that lift on the left side of the parachute can be written by a function LL (x_{1L}, x_{2L}, v, w), and lift on the right side of the parachute can be written by a function L_{R} (x_{1R}, x_{2R}, v, w). At this occasion, it is possible to configure a model by assuming that the descent rate y is expressed by the following equation. Note that, in describing each function of the following equation, description of a variable is omitted. Further, for simplification, it is assumed that a sum of masses of a parachute and a payload (unmanned aircraft) is 1.

y=(aR_{L}+bR_{R}+cL_{L}+dL_{R})Δt (Equation 1)

where a, b, c, and d are coefficients, and Δt is a unit time.
The above-described coefficients a, b, c, and d vary depending on a current mounting state on the unmanned aircraft, and a surrounding environmental condition. These coefficients are referred to as control model characteristic values. It is possible to set, for each of the control model characteristic values, an initial value which is determined based on a structure of the parachute.

Likewise, it is assumed that a turn rate z can be modeled by the following equation. Note that, for simplification, it is assumed that a sum of inertia moments of the parachute and the payload is 1.

z=(hR_{L}+iR_{R}+jL_{L}+kL_{R})Δt (Equation 2)

The above-described coefficients h, i, j, and k are also control model characteristic values, and an initial value based on a structure of the parachute is set for each of the control model characteristic values.

In the zone of the control model configuration S3, the descent landing control device actively increases or decreases a turn rate and a descent rate by the parachute. Further, the descent landing control device calculates a control model characteristic value necessary for adjusting the turn rate and the descent rate, based on a current mounting state on the unmanned aircraft, and a surrounding environmental condition. By determining the control model characteristic value as described above, control model configuration is implemented. Note that the control model characteristic value greatly varies depending on a state of the unmanned aircraft and a surrounding environmental condition. In view of the above, it is necessary to calculate the control model characteristic value, as a value when the landing apparatus is actually operated. Adjustment of the control model characteristic value can be performed as follows, for example. First, a plurality of equations in which each of the control model characteristic values a, b, c, and d is increased or decreased from a current value within a predetermined range by a predetermined scale in (Equation 1), which expresses a control model on a descent rate, are generated. For example, when two values are set on each of the plus side and the minus side, four values can be set for one characteristic value. Since the number of types of characteristic values is four, it is possible to generate 4⁴=256 equations. Further, a descent rate is calculated by substituting a current control value in all the equations, and combination most approximate to an actual descent rate is employed. At this occasion, as far as a difference lies within a threshold value range, the calculation value does not have to completely coincide with the actual descent rate. When there is no combination that lies within the threshold value range, a procedure in which re-calculation is performed by increasing or decreasing the scale may be employed. In either case, it is necessary to employ a calculation method in which it is empirically verified that a calculation result does not diverge. Likewise, adjustment of a characteristic value on a turn rate is performed by employing (Equation 2). A plurality of equations in which each of the control model characteristic values h, i, j, and k is changed within a predetermined range by a predetermined scale are generated. And a turn rate is calculated in all the equations, and combination most approximate to an actual turn rate is employed from among the turn rates. At this occasion, as far as a difference lies within a threshold value range, the calculation value does not have to completely coincide with the actual turn rate. The above-described description describes one example of a specific calculation method. The example embodiment is not limited to the above calculation method. As far as a method of approximating a calculation result of a control model to an actual descent rate and an actual turn rate is available, another calculation method may be employed.

Descent landing control S4 is a zone where the landing apparatus performs descent and landing control, while acquiring information around the own apparatus. As described in the second example embodiment, in the zone, a position of a dangerous object is detected, a movement target place capable of avoiding the dangerous object is calculated, and the parachute is controlled in such a way as to move to the movement target place.

As described above, the control model characteristic value greatly varies depending on a state of the unmanned aircraft, and a surrounding environmental condition. Therefore, also in the zone of the descent landing control S4, re-calculation of the control model characteristic value is periodically performed, and the control model is adjusted in such a way as to be in conformity with a current condition. This process is control model adjustment S5. Such process is performed since a posture of the unmanned aircraft and a surrounding environmental condition change also during descent. And it is necessary to correct the control model characteristic value calculated in the control model configuration S3, each time when the posture of the unmanned aircraft and the surrounding environmental condition change. Specifically, it is desirable to optimize the control model characteristic value on a real-time basis in conformity with a change in the environment.

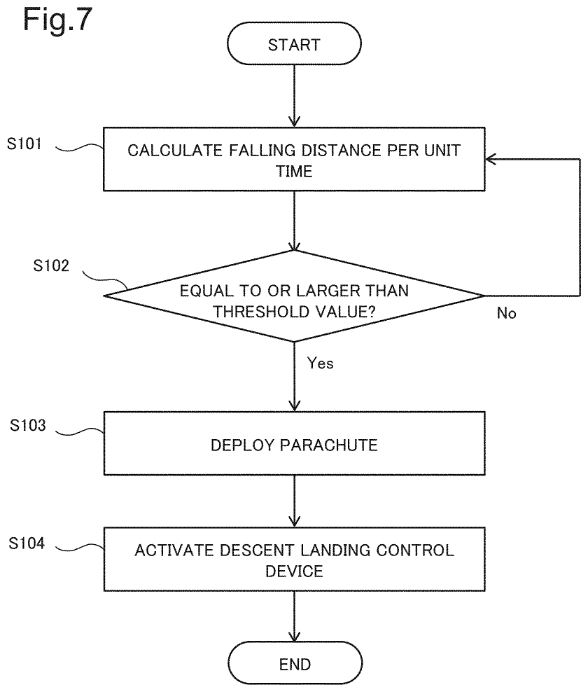

FIG. 7 is a flowchart illustrating an operation of falling detection processing and parachute deployment processing of the landing apparatus 100. In the falling detection processing, first, calculation of a falling distance per unit time is performed (S101). The falling detecting device 150 constantly acquires an acceleration signal from the 3-axis accelerometer 151 for falling detection, integrates the acceleration signals, and periodically calculates a falling distance per unit time, namely, a falling speed. When the falling speed calculated herein is smaller than a threshold value set in advance (S102_No), the process returns to S101, and calculation of a falling speed is continued. On the other hand, when the falling speed is equal to or larger than the threshold value (S102_Yes), the falling detecting device 150 determines that the unmanned aircraft 200 is falling. And the falling detecting device 150 transmits, to the parachute deploying device 110 and the system control device 130, a notification on falling. When receiving the notification on falling, the parachute deploying device 110 deploys the parachute 111 (S103). Further, when receiving the notification on falling, the system control device 130 activates the descent landing control device 131 (S104).

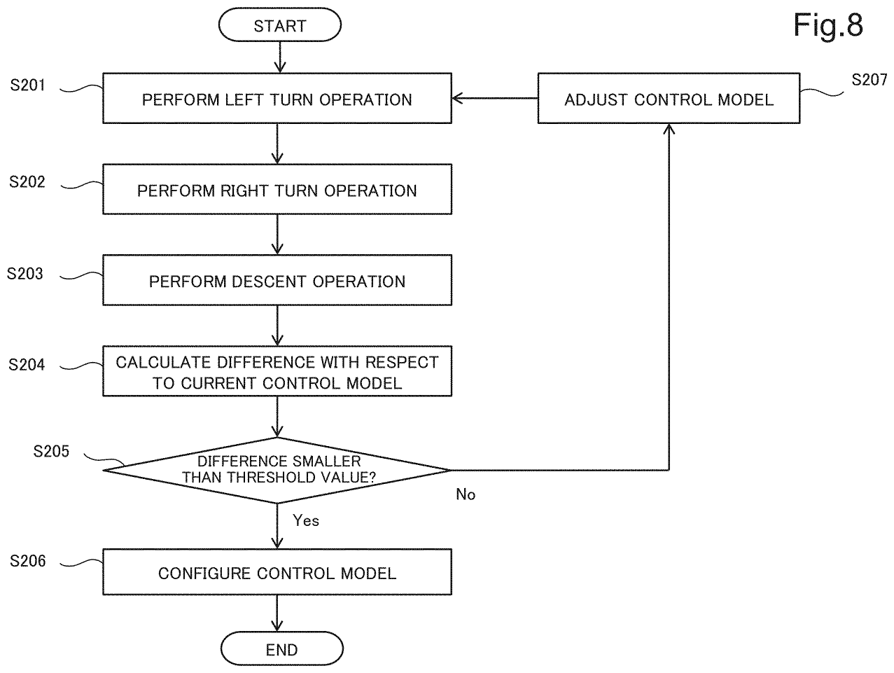

FIG. 8 is a flowchart illustrating parachute control model configuration processing in emergency landing control of the present example embodiment. In control model configuration, first, a test of measuring a behavior (a descent rate and a turn rate) of a parachute when control is actually performed is conducted. In the flowchart of FIG. 8, Steps S201 to S203 are the test operation.

First, for example, the left control wire L_113L is wound up for a predetermined period set in advance to shorten the left control wire L_113L by a predetermined amount, and a left turn operation is performed (S201). Further, a turn rate at this time is stored. Next, for example, the right control wire R_113R is wound up for a predetermined period set in advance to shorten the right control wire R_113R by a predetermined amount, and a right turn operation is performed (S202). Further, a turn rate at this time is stored. Then, for example, both of the control wires are wound up by a predetermined amount, and a descent operation is performed (S203). Further, a descent rate at this time is stored. By the above-described operation, a relationship between a control wire winding amount, and an actual change in turn rate and descent rate is recorded. Note that, the order of left turn, right turn, and descent operation is at random.

Next, a difference between an actual measurement value on a wire winding amount (length), a turn rate, and a descent rate acquired by the operations, and a predicted value calculated from a current control model characteristic value is calculated (S204). Further, when the difference is smaller than a threshold value set in advance (S205_Yes), configuration of a parachute control model is completed (S206). On the other hand, when the difference is equal to or larger than the threshold value (S205_No), adjustment of the parachute control model is performed by adjusting the parachute control model characteristic value (S207). Further, the left turn operation in S201, the right turn operation in S202, and the descent operation in S203 are performed again to verify whether the current parachute control model is appropriate.

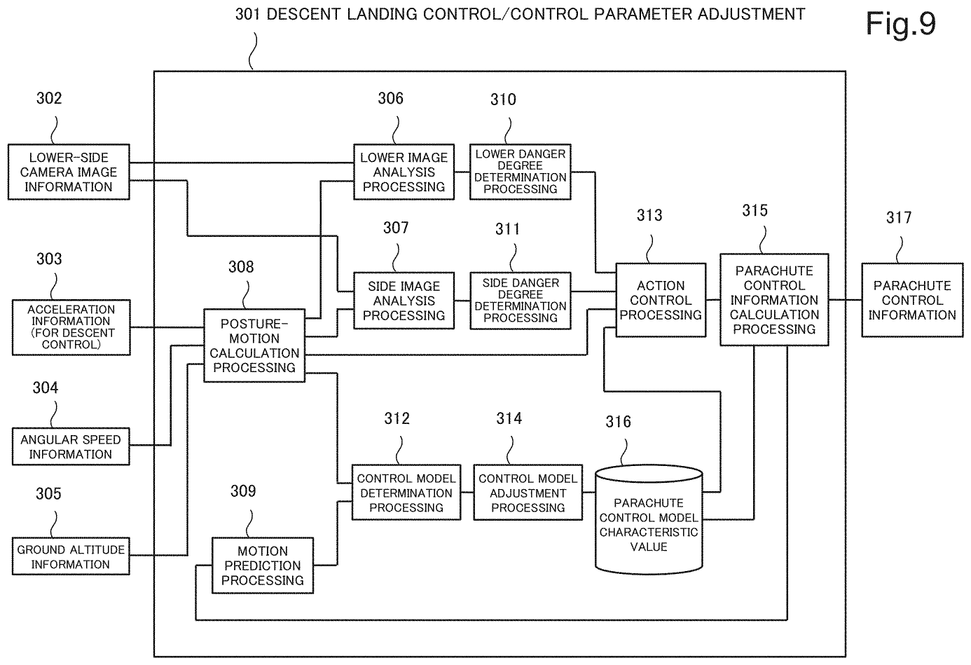

FIG. 9 is a block diagram illustrating a flow of data in descent landing control and control parameter adjustment of the present example embodiment.

Descent landing control/control parameter adjustment 301 is processing to be performed by the descent landing control device 131. The descent landing control device 131 receives, as an input signal, lower-side camera image information 302, acceleration information (for descent control) 303, angular speed information 304, and ground altitude information 305. And the descent landing control device 131 transmits, as an output signal, parachute control information 317.

Posture-motion calculation processing 308 is processing of periodically calculating, from the acceleration information (for descent control) 303, the angular speed information 304, and the ground altitude information 305, posture and motion information (movement information) of the own apparatus. Since the processing is general in an inertial navigation device, detailed description thereof is omitted herein.

Lower image analysis processing 306 is processing of calculating, from lower and side image information input from the lower-side camera image information 302, and posture and motion information input from the posture-motion calculation processing 308, image information and three-dimensional spatial information on the entire periphery except for an upper region. Since an image processing method employed herein is general, detailed description thereof is omitted. Image information and three-dimensional spatial information in a lower direction are extracted from the information acquired herein, and set as an output of the lower image analysis processing 306.

Likewise, side image analysis processing 307 is processing of outputting, from the lower and side image information input from the lower-side camera image information 302, and the posture and motion information input from the posture-motion calculation processing 308, image information in a side surface direction and three-dimensional spatial information.

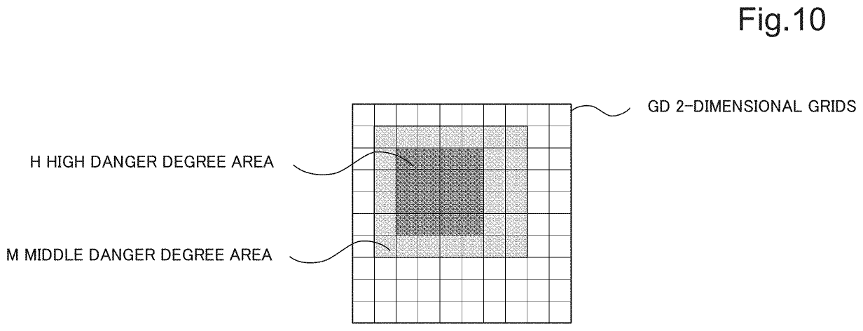

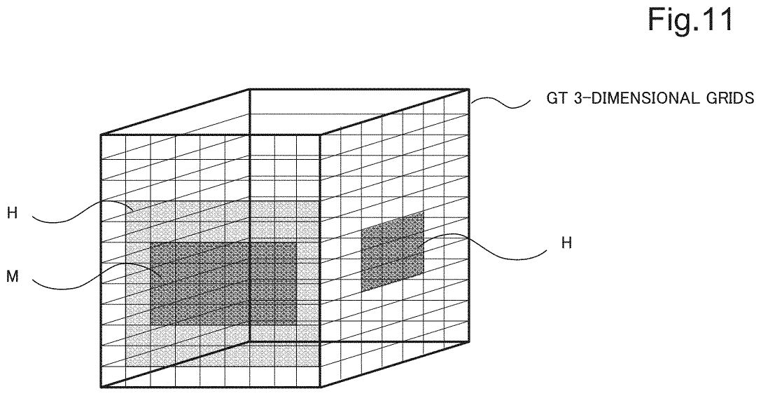

Lower danger degree determination processing 310 is processing of determining a degree of danger of the unmanned aircraft at each position in a lower direction, based on image analysis data input from the lower image analysis processing 306. By the processing, for example, a high degree of danger is set at a position where a dangerous object which is needed to be avoided is present. In the processing, image information in a lower direction and three-dimensional spatial information calculated by the lower image analysis processing 306 are set as an input, and lower danger degree determination information on two-dimensional grids GD of a two-dimensional grid shape is set as an output. FIG. 10 is one example of danger degree determination. A dark color portion in the drawing indicates a high danger degree area H, and a light color portion indicates a middle danger degree area M.

In the lower danger degree determination processing 310 described above, moving body detection is performed for detecting a target object to be avoided, which is present in a lower direction of the unmanned aircraft. Moving body detection can be performed by using an optical flow or the like, which is acquired from image information, for example. As the moving body, for example, a pedestrian, an automobile, and the like in motion are conceived. It is possible to apply weighting to a degree of danger, as necessary, according to a type of an object recognized by image processing, for example. For example, it is possible to set a high degree of danger in the vicinity of a moving body as described above, or to set a high degree of danger to a still object, which is determined to be a human or a car by image recognition. As described above, a degree of danger is set at each grid point. Note that, since a method of setting a degree of danger herein changes according to an operating condition, parameterization is required, and details thereof is not described herein.

Side danger degree determination processing 311 is processing of determining a degree of danger at each position of the unmanned aircraft in a side surface direction. By the processing, for example, a high degree of danger is set at a position where a dangerous object which is needed to be avoided is present. In the processing, image information in a side surface direction and three-dimensional spatial information calculated by the side image analysis processing 307 are set as an input, and, for example, side danger degree determination information on three-dimensional grids GT of a three-dimensional grid shape is set as an output. FIG. 10 illustrates one example of danger degree setting. A dark color portion in the drawing indicates a high danger degree area H, and a light color portion indicates a middle danger degree area M.

A target object to be avoided, which is present in a side surface direction of the unmanned aircraft, is a tall building and the like, which may cause collision with the unmanned aircraft. Therefore, all objects of a certain height, which are acquired by three-dimensional spatial information, are set as targets to be avoided, and a degree of danger is set for the targets. As described above, a degree of danger is set at each place in a side direction.

Action control processing 313 calculates action control appropriate for avoiding a dangerous position, based on the input lower danger degree determination information (310), the input side danger degree determination information (311), the input posture-motion information (308), and a parachute control model characteristic value (316). The action control is control for moving the parachute to a target place, and is indicated by a turn rate and a descent rate being basic control parameters of the parachute, for example. Further, in the action control processing 313, a result is output to parachute control information calculation processing 315. Note that details of the above-described action control will be described later.

The parachute control information calculation processing 315 calculates control information for performing target control, based on a turn rate and a descent rate calculated by the action control processing 313, and a control model employing the parachute control characteristic value 316. The control information is calculated, for example, as winding/feeding amounts, and feeding positions of the left and right control wires. The parachute control information calculated herein is converted into a signal for mechanically driving the reel 123 and the wire guide 122 by the parachute control information 317, and the signal is transmitted to the parachute control device 120.

Control model determination processing 312 is processing of determining whether it is necessary or not to adjust a current control model, based on a difference between motion prediction information calculated by inputting a current control value to a current parachute control model, and actually measured posture-motion information. The motion prediction information and the posture-motion information include a turn rate and a descent rate, for example. Herein, the motion prediction information is calculated by the motion prediction processing 309, and the posture-motion information is calculated by the posture-motion calculation processing 308, based on the outputs (303, 304, and 305) of sensors. In the control model determination processing 312, for example, when a difference between motion prediction information (a turn rate and a descent rate) calculated from a control model, and actual motion information is equal to or larger than a predetermined threshold value, parachute control model adjustment is determined to be required; and when the difference is smaller than the threshold value, parachute control model adjustment is determined not to be required. Herein, when parachute control model adjustment is determined to be required, the parachute control model is re-adjusted by a control model adjustment processing 314, and the parachute control model characteristic value 316 is updated.

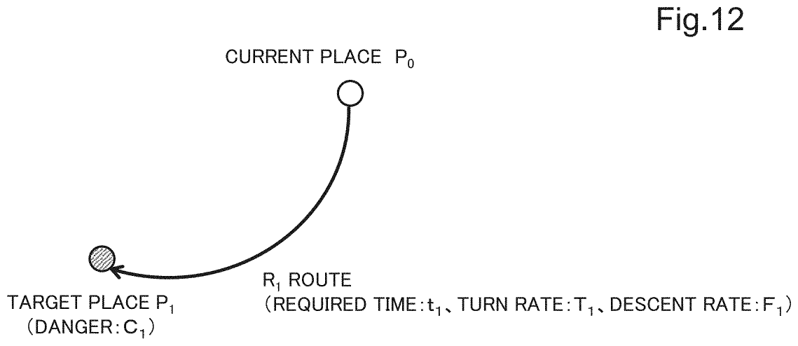

A method of calculating an action appropriate for avoiding a dangerous object, which is performed by the action control processing 313 is as follows. First, as illustrated in FIG. 12, a time t₁ required for the unmanned aircraft to reach from a current place P₀ to a target place P₁, and a turn rate T₁ and a descent rate F₁ to be set are calculated from a current parachute control characteristic parameter and current posture data of the own apparatus. In other words, FIG. 12 illustrates a case in which the unmanned aircraft is expected to reach the target place P₁ of danger C₁ within the required time t₁, when control at the turn rate T₁ and the descent rate F₁ is performed. Note that the danger C₁ can be optionally set by a user, as necessary. A high numerical value is set to an object, which may be seriously damaged, or which may cause serious damage to a collided object, as a result of collision. For example, a high value may be given to a human, an automobile, and the like, and a low value may be given to a bush.

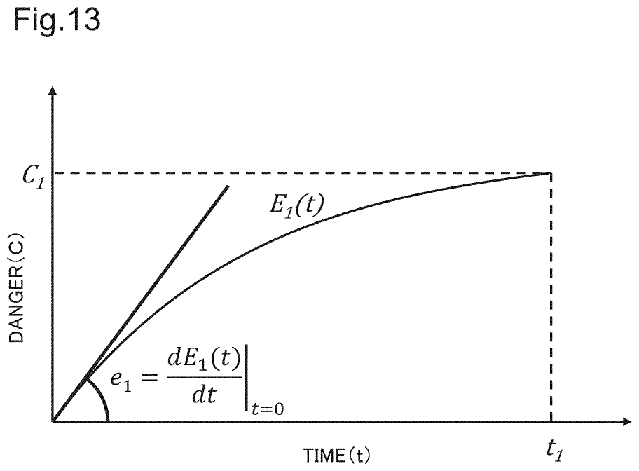

FIG. 13 is a graph illustrating one example of an evaluation function E(t) for calculating danger C at each point of time in the case of FIG. 12. The evaluation function is defined as a function in which the danger C comes close to the danger C₁ set at the target place P₁ as time elapses, when control of causing the unmanned aircraft to approach from the current place P₀ to the target place P₁ is continued. Such a function can be expressed, for example, by an equation: E₁(t)=C₁(1−exp(−A*t/t₁)), where A is a constant. Note that, herein, it is assumed that danger at the current place P₀ is 0. According to the evaluation function, as time elapses, the unmanned aircraft approaches P₁, the danger increases accompanied by the approach, and the danger becomes C₁ when the unmanned aircraft reaches P₁. Further, as illustrated in FIG. 12, it is possible to express, by a gradient e₁, a degree of danger at the current point of time t=0, when control of causing the unmanned aircraft to approach the target place P₁ of the danger C₁ is performed. Specifically, e₁ indicates a degree of danger relating to control at the turn rate T₁ and the descent rate F₁. In view of the above, e₁ is referred to as a control danger degree.

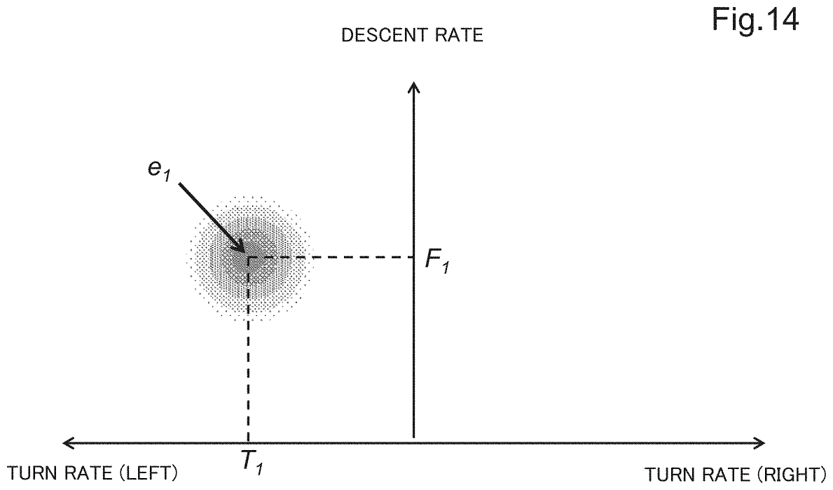

Next, as illustrated in FIG. 14, the points representing values with e₁ as a parameter are plotted in a control parameter space using e₁, F₁, T₁ which are calculated at the target place P1. The distribution of the points is centered on coordinate (F1, T1). The control parameter space is a space having, as dimensions, a descent rate and a turn rate being basic control parameters of a parachute, and having a degree of influence of danger on control indicated at each coordinate, as a value of control danger degree. Control by a parameter having a high value as the control danger degree means a high degree of danger, and control by a parameter having a low value as the control danger degree means a relatively low degree of danger.

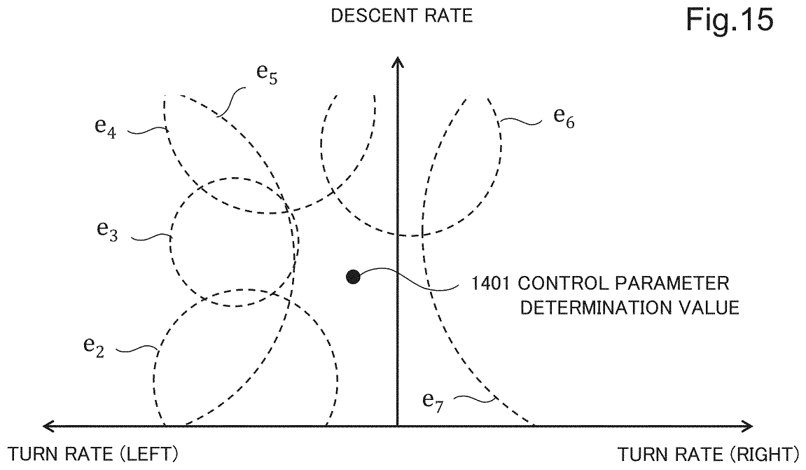

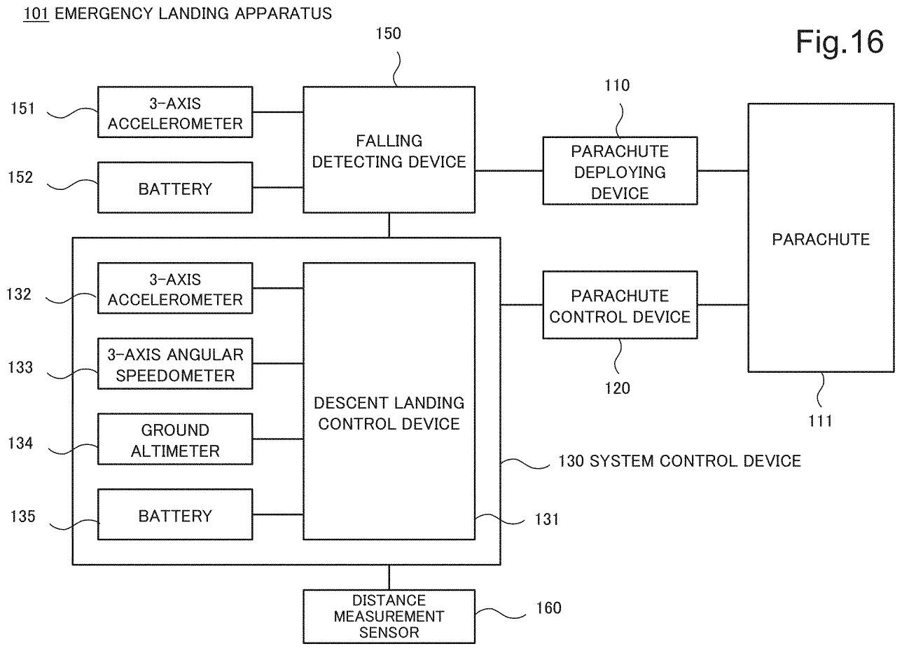

The above-described processing is performed by using each of grids on lower danger degree determination information and side danger degree determination information, as a target place. Consequently, a plurality of distributions indicating overall danger with respect to the basic control parameters, as exemplified in FIG. 15, is calculated in the control parameter space. In FIG. 15, a distribution on a control danger degree e becomes a distribution as expressed by each of circles e₂ to e₇. Further, one point of place having a lowest value as the control danger degree in the control parameter space is set as a control parameter determination value 1401.

Herein, control danger degree calculation and plotting in the control parameter space do not have to be performed for all grids calculated by lower danger degree determination information and side danger degree determination information. For example, control can be performed only for a grid having a high degree of danger, or a grid present at a near distance from the own apparatus.

Further, it is possible to provide in advance a distribution in a control parameter space. For example, in the example illustrated in FIG. 14, by setting a low control danger degree in an area where a turn rate is low and a descent rate is high, when there is no target object to be avoided, an operation that the unmanned aircraft descends rapidly without turning is selected.

As described above, the landing apparatus according to the present example embodiment is able to guide an unmanned aircraft in a state of being unable to fly to a place with a low degree of danger such as collision with an obstacle, and safely land the unmanned aircraft.

### Fourth Example Embodiment

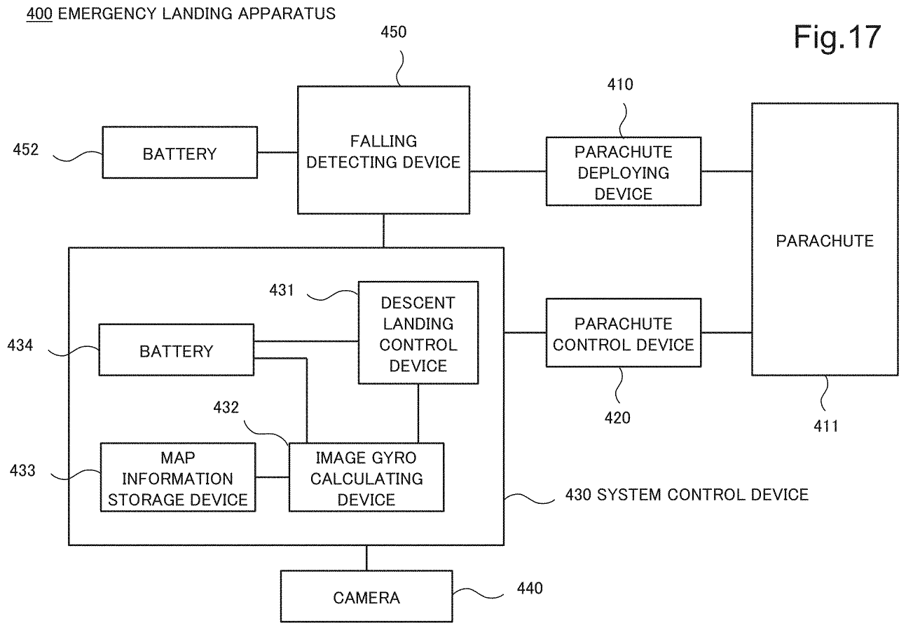

In the third example embodiment, an optical camera is employed as a means for acquiring dangerous object position information. However, it is also possible to employ an active distance measurement sensor such as a LIDAR, a radar, and an ultrasonic distance measurement sensor, in place of the optical camera. FIG. 17 illustrates a block diagram of a landing apparatus 101 employing a distance measurement sensor 160 in place of a camera. A descent landing control device 131 performs object recognition, danger degree calculation, and the like by using distance measurement data measured by the distance measurement sensor 160, in place of an optical image. A configuration other than the above is similar to the second example embodiment.

In particular, at nighttime when performance of an optical camera is limited, employing these active sensors enables to acquire accurate surrounding information. Note that the above-described LIDAR is abbreviation of Light Detection and Ranging.

### Fifth Example Embodiment

In the second and third example embodiments, an accelerometer, an angular speedometer, and a ground altimeter are employed for acquiring posture and motion information of the own apparatus. However, these sensors can be omitted by performing gyro processing using image information.

FIG. 17 is a block diagram illustrating one example of a landing apparatus 400 employing image gyro. The landing apparatus 400 includes a parachute deploying device 410, a parachute control device 420, a system control device 430, a camera 440, and a falling detecting device 450.

The system control device 430 includes a descent landing control device 431, an image gyro calculating device 432, a map information storage device 433, and a battery 434. The image gyro calculating device 432 calculates a position and a ground altitude of the own apparatus, based on image information acquired from the camera 440, and map information stored in the map information storage device 433. Further, the image gyro calculating device 432 calculates a speed and an acceleration from a timewise change of these parameters. When a calculated lower acceleration or a calculated falling speed exceeds a predetermined threshold value, the falling detecting device 450 detects falling, and operates the parachute deploying device 410 to deploy a parachute. Note that, herein it is assumed that the falling detecting device 450 is driven by a battery 452 different from the battery 434 for driving the descent landing control device. However, the falling detecting device 450 may be driven by the same battery as that of the descent landing control device. The descent landing control device 431 calculates a degree of danger at each place in a lower direction and a side direction, based on a position, a ground altitude, a speed, an acceleration, and the like calculated by the image gyro calculating device 432. Further, the descent landing control device 431 controls the parachute control device 420 in such a way that a parachute 411 moves while avoiding a position of a high degree of danger, and guides the unmanned aircraft to a safe place.

As described above, the present example embodiment is able to guide and land an unmanned aircraft on a safe place, without using an accelerometer, an angular speedometer, and a ground altimeter. Note that, in FIG. 17, the falling detecting device 450 is separated from the system control device 430. However, the falling detecting device 450 may be configured as a part of the system control device 430.

In the foregoing, the present invention is described by using the above-described example embodiments as an exemplary example. The present invention, however, is not limited to the above-described example embodiments. Specifically, the present invention can be applied to various aspects comprehensible to a person skilled in the art within the scope of the present invention.

The scope of the present invention also includes a program causing a computer to execute processing of the first to fourth example embodiments, and a recording medium having the program stored thereon. As the recording medium, for example, it is possible to employ a magnetic disk, a magnetic tape, an optical disc, a magneto-optical disk, a semiconductor memory, and the like.

### (Supplementary Note 1)

A landing apparatus comprising:

a dangerous object position detecting means for detecting a position of a dangerous object around an unmanned aircraft which performs landing by using a parachute;

a movement target position calculating means for calculating a movement target position for use when the unmanned aircraft moves while avoiding the dangerous object, based on a position of the dangerous object detected by the dangerous object position detecting means; and

a parachute control means for controlling the parachute in such a way that the unmanned aircraft moves to the movement target position.

### [Supplementary Note 2]

The landing apparatus according to Supplementary note 1, further comprising:

a falling detecting means for detecting falling of the unmanned aircraft; and

a

parachute deploying means for deploying a parachute, when the falling detecting means detects falling of the unmanned aircraft.

### [Supplementary Note 3]

The landing apparatus according to Supplementary note 1 or 2, wherein

the movement target position calculating means generates a grid associated with a lower coordinate and a side coordinate of the unmanned aircraft, and sets a degree of danger based on a position of the dangerous object with respect to each point of the grid.

### [Supplementary Note 4]

The landing apparatus according to Supplementary note 3, further comprising

at least one pair of control wires for connecting the parachute and the parachute control means, wherein

the parachute control means includes

a reel for controlling a feeding amount of each of the at least one pair of control wires, and

a wire guide for controlling a feeding position of each of the at least one pair of control wires.

### [Supplementary Note 5]

The landing apparatus according to Supplementary note 4, wherein

the parachute control means

configures a parachute control model for predicting a behavior of the parachute, when the parachute is controlled,

based on a relationship between a feeding amount and a feeding position of each of the at least one pair of control wires, and an actual behavior of the parachute.

### [Supplementary Note 6]

The landing apparatus according to Supplementary note 5, wherein

the parachute control means

generates a control parameter space in which a turn rate and a descent rate of the parachute are set as dimensions,

calculates a control danger degree associated with the degree of danger with respect to each point in the control parameter space, and

selects control associated with a point, in the control parameter space, having a low value as the control danger degree, based on the parachute control model.

### [Supplementary Note 7]

The landing apparatus according to any one of Supplementary notes 3 to 6, wherein

the movement target position calculating means

sets the grid having the degree of danger being low, as a movement target position.

### [Supplementary Note 8]

The landing apparatus according to any one of Supplementary notes 1 to 7, wherein the dangerous object position detecting means is a camera.

### [Supplementary Note 9]

The landing apparatus according to any one of Supplementary notes 1 to 7, wherein the dangerous object position detecting means is a distance measurement sensor.

### [Supplementary Note 10]

A landing control method comprising:

detecting a position of a dangerous object around an unmanned aircraft which performs landing by using a parachute;

calculating a movement target position for use when the unmanned aircraft moves while avoiding the dangerous object, based on a position of the dangerous object; and

controlling the parachute in such a way that the unmanned aircraft moves to the movement target position.

### [Supplementary Note 11]

The landing control method according to Supplementary note 10, further comprising:

detecting falling of the unmanned aircraft; and

deploying a parachute, when falling of the unmanned aircraft is detected.

### [Supplementary Note 12]

The landing control method according to Supplementary note 11, further comprising

generating a grid associated with a lower coordinate and a side coordinate of the unmanned aircraft, and setting a degree of danger based on a position of the dangerous object with respect to each point of the grid.

### [Supplementary Note 13]

The landing control method according to Supplementary note 12, further comprising:

providing at least one pair of control wires for connecting the unmanned aircraft and the parachute;

controlling a feeding amount of each of the at least one pair of control wires from the unmanned aircraft; and

controlling a feeding position of each of the at least one pair of control wires from the unmanned aircraft.

### [Supplementary Note 14]

The landing control method according to Supplementary note 13, further comprising

configuring a parachute control model for predicting motion of the parachute when the parachute is controlled,

based on a relationship between a feeding amount and a feeding position of each of the at least one pair of control wires, and an actual behavior of the parachute.

### [Supplementary Note 15]

The landing control method according to Supplementary note 14, further comprising

adjusting the parachute control model,

based on a relationship between control of the parachute actually performed during descent of the parachute, and motion of the parachute associated with control of the parachute.

### [Supplementary Note 16]

The landing control method according to Supplementary note 14 or 15, further comprising:

generating a control parameter space in which a turn rate and a descent rate of the parachute are set as dimensions;

calculating a control danger degree associated with the degree of danger with respect to each point in the control parameter space; and

selecting control associated with a point, in the control parameter space, having a low value as the control danger degree, based on the parachute control model.

### [Supplementary Note 17]

The landing control method according to Supplementary note 16, further comprising

setting a predetermined offset value to the control danger degree with respect to each point in the control parameter space.

### [Supplementary Note 18]

The landing control method according to any one of Supplementary notes 12 to 17, further comprising

setting the grid having the degree of danger being low, as a movement target position.

### [Supplementary Note 19]

The landing control method according to any one of Supplementary notes 10 to 18, further comprising performing position detection of the dangerous object, based on captured data.

### [Supplementary Note 20]

The landing control method according to any one of Supplementary notes 10 to 18, further comprising performing position detection of the dangerous object, based on distance measurement data.

### [Supplementary Note 21]

A program recording medium having a landing control program recorded thereon, the landing control program comprising:

a step of detecting a position of a dangerous object around an unmanned aircraft which performs landing by using a parachute;

a step of calculating a movement target position for use when the unmanned aircraft moves while avoiding the dangerous object, based on a position of the dangerous object; and

a step of controlling the parachute in such a way that the unmanned aircraft moves to the movement target position.

### REFERENCE SIGNS LIST

4, 150, 450 Falling detecting device
5, 110, 410 Parachute deploying device
1 Dangerous object position detecting device
2 Movement target place calculating device
3, 120, 420 Parachute control device
100, 101, 400 Landing apparatus
111, 411 Parachute
112 Wire
113 Control wire
130, 430 System control device
131, 431 Descent landing control device
132, 151 3-axis accelerometer
133 3-axis angular speedometer
134 Ground altimeter
135, 152, 434, 452 Battery
140, 440 Camera
160 Distance measurement sensor
432 Image gyro calculating device
433 Map information storage device

What is claimed is:

1. A landing apparatus comprising:
a dangerous object position detecting device for detecting a position of a dangerous object around an unmanned aircraft which performs landing by using a parachute;
a movement target position calculating device for calculating a movement target position for use when the unmanned aircraft moves while avoiding the dangerous object, based on a position of the dangerous object detected by the dangerous object position detecting device; and
a parachute control device for controlling the parachute in such a way that the unmanned aircraft moves to the movement target position.

2. The landing apparatus according to claim 1, further comprising:
a falling detecting device for detecting falling of the unmanned aircraft; and
a parachute deploying device for deploying a parachute, when the falling detecting device detects falling of the unmanned aircraft.

3. The landing apparatus according to claim 1, wherein
the movement target position calculating device generates a grid associated with a lower coordinate and a side coordinate of the unmanned aircraft, and sets a degree of danger based on a position of the dangerous object with respect to each point of the grid.

4. The landing apparatus according to claim 3, further comprising
at least one pair of control wires for connecting the parachute and the parachute control device, wherein
the parachute control device includes
a reel for controlling a feeding amount of each of the at least one pair of control wires, and
a wire guide for controlling a feeding position of each of the at least one pair of control wires.

5. The landing apparatus according to claim 4, wherein
the parachute control device
configures a parachute control model for predicting a behavior of the parachute, when the parachute is controlled,
based on a relationship between a feeding amount and a feeding position of each of the at least one pair of control wires, and an actual behavior of the parachute.

6. The landing apparatus according to claim 5, wherein
the parachute control device
generates a control parameter space in which a turn rate and a descent rate of the parachute are set as dimensions,
calculates a control danger degree associated with the degree of danger with respect to each point in the control parameter space, and
selects control associated with a point, in the control parameter space, having a low value as the control danger degree, based on the parachute control model.

7. The landing apparatus according to claim 3, wherein
the movement target position calculating device
sets the grid having the degree of danger being low, as a movement target position.

8. The landing apparatus according to claim 1, wherein the dangerous object position detecting device is a camera.

9. The landing apparatus according to claim 1, wherein the dangerous object position detecting device is a distance measurement sensor.

10. A landing control method comprising:
detecting a position of a dangerous object around an unmanned aircraft which performs landing by using a parachute;
calculating a movement target position for use when the unmanned aircraft moves while avoiding the dangerous object, based on a position of the dangerous object; and
controlling the parachute in such a way that the unmanned aircraft moves to the movement target position.

11. The landing control method according to claim 10, further comprising:
detecting falling of the unmanned aircraft; and
deploying a parachute, when falling of the unmanned aircraft is detected.

12. The landing control method according to claim 11, further comprising
generating a grid associated with a lower coordinate and a side coordinate of the unmanned aircraft, and setting a degree of danger based on a position of the dangerous object with respect to each point of the grid.

13. The landing control method according to claim 12, further comprising:
providing at least one pair of control wires for connecting the unmanned aircraft and the parachute;
controlling a feeding amount of each of the at least one pair of control wires from the unmanned aircraft; and
controlling a feeding position of each of the at least one pair of control wires from the unmanned aircraft.

14. The landing control method according to claim 13, further comprising
configuring a parachute control model for predicting motion of the parachute when the parachute is controlled,
based on a relationship between a feeding amount and a feeding position of each of the at least one pair of control wires, and an actual behavior of the parachute.

15. The landing control method according to claim 14, further comprising
adjusting the parachute control model,
based on a relationship between control of the parachute actually performed during descent of the parachute, and motion of the parachute associated with control of the parachute.

16. The landing control method according to claim 14, further comprising:
generating a control parameter space in which a turn rate and a descent rate of the parachute are set as dimensions;
calculating a control danger degree associated with the degree of danger with respect to each point in the control parameter space; and
selecting control associated with a point, in the control parameter space, having a low value as the control danger degree, based on the parachute control model.

17. The landing control method according to claim 16, further comprising
setting a predetermined offset value to the control danger degree with respect to each point in the control parameter space.

18. The landing control method according to claim 12, further comprising
setting the grid having the degree of danger being low, as a movement target position.

19. The landing control method according to claim 10, further comprising performing position detection of the dangerous object, based on captured data.

20. (canceled)

21. A program recording medium having a landing control program recorded thereon, the landing control program comprising:
a step of detecting a position of a dangerous object around an unmanned aircraft which performs landing by using a parachute;
a step of calculating a movement target position for use when the unmanned aircraft moves while avoiding the dangerous object, based on a position of the dangerous object; and
a step of controlling the parachute in such a way that the unmanned aircraft moves to the movement target position.
